(19) United States
(12) Patent Application Publication
(10) Pub. No.: US 2023/0399205 A1
(43) Pub. Date: Dec. 14, 2023

(54) Disturbance Employment-Based Sliding Mode Control (DESMC) Method For 4-DOF Tower Crane Systems

(71) Applicants: Xingjian Jing, Jinan (CN); University of Jinan, Jinan (CN)

(72) Inventors: Menghua Zhang, Jinan (CN); Xingjian Jing, Jinan (CN)

(21) Appl. No.: 17/838,233

(22) Filed: Jun. 12, 2022

(51) Int. Cl. B66C 13/48; B66C 13/46

(52) U.S. Cl. CPC B66C 13/48; B66C 13/46

(57) ABSTRACT

The present disclosure provides a disturbance employment-based sliding mode control (DESMC) method for four-degrees-of-freedom (4-DOF) tower crane systems. The method includes the following steps: acquiring parameter data and operating state data of the 4-DOF tower crane systems; conducting, based on the acquired data, disturbance estimation by using a preset nonlinear disturbance observer, and conducting judgment on beneficial disturbance and detrimental disturbance according to a preset disturbance effect indicator (DEI); and adding the beneficial disturbance to a preset sliding mode controller, removing the detrimental disturbance, driving a jib and a trolley to a desired slew angle and a desired target displaced position, respectively, and setting a payload swing angle to 0 or within a preset range. According to the present disclosure, the disturbance effect is distinguished by introducing a DEI, such that good disturbance information is made full use of, and the transient control performance of the system is significantly improved.

### TECHNICAL FIELD

The present disclosure relates to the technical field of transient control for four-degrees-of-freedom (4-DOF) tower crane systems, and in particular to a disturbance employment-based sliding mode control (DESMC) method for 4-DOF tower crane systems.

### BACKGROUND ART

The statement of this part is merely intended to provide background information related to the present disclosure, and does not necessarily constitute the prior art.

Crane system is a typical underactuation system, the number of independent control inputs of which is less than the degrees of freedom to be controlled. As the most widely used means of cargo transport in construction sites, tower crane has the advantages of simple structure, ease of installation, low cost, large payload capacity, low energy consumption and so on. However, due to the inevitable problems of external disturbance, parameter uncertainty, strong coupling, strong nonlinearity, and strong underactuation characteristics existing in the tower crane systems, controller design for the tower crane system is still a complicated and challenging task to achieve. For example, it is difficult to measure system parameters with complete accuracy, given the complexity and variability of the factors that may affect measurements. In addition, external disturbance such as a gust of wind, also imposes a great impact on the stability of the tower crane system. Therefore, in the presence of disturbance, the robustness of the crane system should be taken into full consideration.

In order to better solve the above problems, researchers have proposed a wide range of control methods, mainly including adaptive control, fuzzy logic control, neural network control and so on. By these methods, uncertain-but-bounded dynamics can be effectively dealt with. Besides, DESMC method has satisfactory robustness for unmodeled dynamics, parameter uncertainty, and external disturbance. Therefore, with respect to the tower crane systems, researchers have designed many sliding mode control methods, covering integral sliding mode control, nonlinear sliding mode control, adaptive sliding mode control and neural network sliding mode control. Recently, in order to better eliminate the impact of disturbance on the tower crane systems, researchers have proposed several disturbance observer-based control methods, through which system robustness can be further improved.

However, the inventors have found that most of existing control methods for tower crane system are designed by employing a linearized tower crane system model. When state variables of the system cannot come close enough to the equilibrium point, the linearized model becomes quite different from an original crane model, which may seriously affect the control performance of the system, and may even cause the instability problem. In addition, all of the above robust control methods fail to include the beneficial effects, but completely regard disturbance as a detrimental factor, and eliminate it directly without make full use of the beneficial disturbance, resulting in poor transient control performance.

### SUMMARY

In order to overcome the defects of the prior art, the present disclosure provides a DESMC method for 4-DOF tower crane systems. According to the present disclosure, the disturbance effect is distinguished by introducing a disturbance effect indicator (DEI), such that good disturbance information is made full use of, and the transient control performance of the system is significantly improved.

To achieve the above objective, the present disclosure adopts the following technical solutions:

A first aspect of the present disclosure provides a DESMC method for 4-DOF tower crane systems.

The DESMC method for 4-DOF tower crane systems includes the following steps:

acquiring parameter data and operating state data of the 4-DOF tower crane systems;

conducting, based on the acquired data, disturbance estimation by using a preset nonlinear disturbance observer, and conducting judgment on beneficial disturbance and detrimental disturbance according to a preset DEI; and

adding the beneficial disturbance to a preset sliding mode controller, removing the detrimental disturbance, driving a jib and a trolley to a desired slew angle and a desired target displaced position, respectively, and setting a payload swing angle to be 0 or within a preset range.

A second aspect of the present disclosure provides a DESMC system for 4-DOF tower crane systems.

The DESMC system for 4-DOF tower crane systems includes:

a data acquisition module, which is configured to acquire parameter data and operating state data of the 4-DOF tower crane systems;

a disturbance judgment module, which is configured to conduct, based on the acquired data, disturbance estimation by using a preset nonlinear disturbance observer, and conduct judgment on beneficial disturbance and detrimental disturbance according to a preset DEI; and

a sliding mode control module, which is configured to add the beneficial disturbance to a preset sliding mode controller, remove the detrimental disturbance, drive a jib and a trolley to a desired slew angle and a desired target displaced position, respectively, and set a payload swing angle to be 0 or within a preset range.

A third aspect of the present disclosure provides a medium storing a program, where the program, when executed by a processor, implements steps of the DESMC method for 4-DOF tower crane systems as described in the first aspect of the present disclosure.

A fourth aspect of the present disclosure provides an electronic device, including a memory, a processor, and a program stored in the memory and executable on the processor, where the processor, when executing the program, implements steps of the DESMC method for 4-DOF tower crane systems as described in the first aspect of the present disclosure.

Compared with the prior art, the present disclosure has the following beneficial effects:
1. The method, system, medium or electronic device as described in the present disclosure deliberately introduces a disturbance effect indicator to distinguish the good disturbance effect from the bad one, and then, takes full advantage of the good disturbance effect, consequently increasing the transient control performance dramatically.
2. The method, system, medium or electronic device as described in the present disclosure does not require accurate knowledge about a model (for example, cable length, trolley mass, payload mass, jib inertia moment, friction-related parameters, and external disturbances), thus ensuring satisfactory robustness.
3. The method, system, medium or electronic device as described in the present disclosure is designed and analyzed based on original dynamic model of tower crane systems without any approximation processing. As a consequence, for the designed control method, it has little influence on the control performance when the state variables are not close enough to the equilibrium point.

### BRIEF DESCRIPTION OF THE DRAWINGS

The accompany drawings constituting a part of the present disclosure are intended to provide further understanding of the present disclosure. The exemplary embodiments of the present disclosure and illustrations thereof are used to explain the present disclosure and do not constitute an undue limitation to the present disclosure.

FIG. 1 is a schematic diagram illustrating a 4-DOF tower crane system according to Embodiment 1 of the present disclosure.

FIG. 2 is a flow block diagram illustrating an overall control method according to Embodiment 1 of the present disclosure.

FIG. 3 is a schematic diagram illustrating simulation results of a PD control method, an adaptive control method and a proposed control method according to Embodiment 1 of the present disclosure.

FIG. 4 is a schematic diagram illustrating simulation results of Case 1 according to Embodiment 1 of the present disclosure.

FIG. 5 is a schematic diagram illustrating simulation results of Case 2 according to Embodiment 1 of the present disclosure.

### DETAILED DESCRIPTION OF THE EMBODIMENTS

The present disclosure is described in further detail below with reference to the accompanying drawings and examples.

It should be noted that the following detailed descriptions are all exemplary and aim to further describe the present disclosure. Unless specified otherwise, all terms (including technical terms and scientific terms) used in this embodiment have the same meanings usually understood by a person of ordinary skill in the pertinent technical field of the present disclosure.

It should be noted that the terms used herein are merely used for describing specific examples, but not intended to limit the exemplary examples according to the present disclosure. As used herein, the singular forms are intended to include the plural forms as well, unless the context clearly indicates otherwise, and also, it should be understood that when the terms “include” and/or “comprise” are used in this specification, they indicate that there are features, steps, operations, devices, elements, and/or combinations thereof.

The embodiments in the present disclosure and features in the embodiments may be combined with each other in a non-conflicting manner.

### Embodiment 1

In Embodiment 1 of the present disclosure, uncertainties of disturbance are considered, and a nonlinear disturbance observer is adopted for accurately observing the disturbance; afterwards, based on estimated disturbance information, the DEI is configured to distinguish beneficial disturbance and detrimental disturbance; finally, the DEI and estimated disturbance information are introduced into controller design, and thus a DESMC method is proposed, which includes the following steps:

S1: Construction of error model of 4-DOF tower crane system

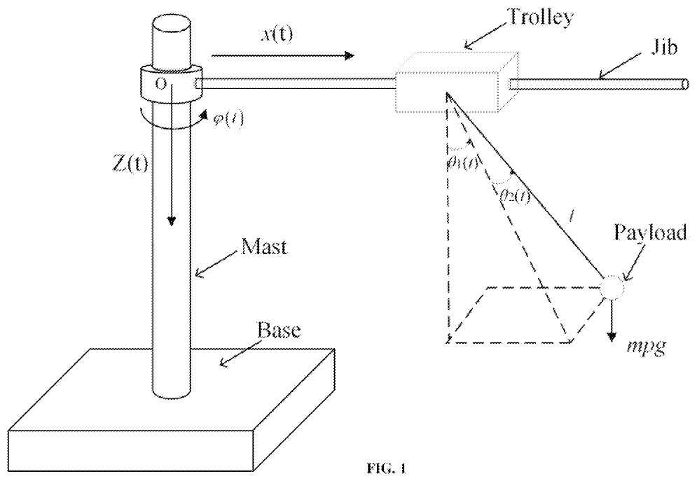

In this embodiment, the accurate positioning and fast swing elimination control are considered for 4-DOF tower crane systems. As shown in FIG. 1, the dynamic model constructed for the 4-DOF tower crane systems is as follows:

[mₚ(S₁²C₂²+S₂²)l²+2mₚxlC₂S₁+J+(Mₜ+mₚ)x²]\ddot{φ}−mₚlS₂\ddot{x}−mₚl²C₁C₂S₂\ddot{θ}₁+mₚl(C₂x+lS₁)\ddot{θ}₂+2(Mₜ+mₚ)x\dot{x}\dot{φ}2mₚlC₁C₂x\dot{φ}\dot{θ}₁−mₚlS₂(2\dot{φ}S₁+\dot{θ}₂)x\dot{θ}₂+2mₚlS₁C₂\dot{φ}\dot{x}+mₚl²S₂₁C₂²\dot{φ}\dot{θ}₁+mₚl²S₁S₂C₂\dot{θ}₁²+mₚl²C₁²S₂₂\dot{φ}\dot{θ}₂+2mₚl²C₁S₂²\dot{θ}₁\dot{θ}₂=F_{φ}−F_{rφ}+d_{φ} (1)

−1mₚlS₂\ddot{φ}+(Mₜ+mₚ)\ddot{x}+mₚlC₁C₂\ddot{θ}₁−mₚlS₁S₂\ddot{θ}₂−(Mₜ+mₚ)x\dot{φ}²−2mₚlC₁S₂\dot{θ}₁\dot{θ}₂−mₚlC₂[S₁(\dot{φ}²+\dot{θ}₁²+\dot{θ}₂²)+2\dot{φ}\dot{θ}₂]=Fₓ−Fᵣₓ+dₓ (2)

−mₚl²C₁C₂S₂\ddot{φ}+mₚlC₁C₂\ddot{x}+mₚl²C₂²\ddot{θ}₁−mₚlC₁C₂(x+lS₂C₂)\dot{φ}²−2mₚl²C₂(\dot{φ}C₁C₂+\dot{θ}₁S₂)\dot{θ}₂+mₚglS₁C₂=0 (3)

mₚl(C₂x+lS₁)\ddot{φ}−mₚlS₁S₂\ddot{x}+mₚl²\ddot{θ}₂+2mₚlC₂\dot{x}\dot{φ}+mₚl(xS₁S₂−lC₁²S₂C₂)\dot{φ}²+2mₚl²C₁C₂²\dot{φ}\dot{θ}₁+mₚl²\dot{θ}₁²S₂C₂+mₚglC₁S₂=0 (4)

where, the meanings of variables, parameters, and symbols of a system in Eqs. (1)-(4) are shown in Table 1.

TABLE 1
Variables, parameters, and symbols
of the 4-DOF tower crane system

| Variables/Parameters/ | |
|---|---|
| Symbols | Meaning |
| φ | Jib slew angle |
| x | Trolley displacement |
| θ₁, θ₂ | Payload swing angle |
| l | Cable length |
| Mₜ | Trolley mass |
| mₚ | Payload mass |
| J | Jib inertia moment |
| g | Gravitational acceleration |
| S₁, S₂, C₁, C₂ | Abbreviations of sin θ₁, sin θ₂, cos θ₁, cos θ₂ |
| d_{φ}, dₓ | Disturbances including internal disturbances |
| | and external disturbances |
| F_{rφ} | Jib friction torque |
| Fᵣₓ | Trolley friction force |
| F_{φ} | Running torque |
| Fₓ | Translational force |

After a series of experimental measurement, the friction torque and friction force can be expressed as follows:

F_{rφ}=F_{rφ1} tanh(ρ_{φ}\dot{φ})+F_{rφ2}|\dot{φ}|\dot{φ} (5)

Fᵣₓ=Fᵣₓ₁ tanh(ρₓ\dot{x})+Fᵣₓ₂|\dot{x}|\dot{x} (6)

where F_{rφ1}, F_{drφ2}, Fᵣₓ₁, Fᵣₓ₂, ρ_{φ} and ρₓ denote friction-related coefficients.

For the sake of brevity, Eqs. (1)-(4) are re-written as the following matrix form:

M(q)\ddot{q}+C(q, \dot{q})\dot{q}+G(q)=u+F* (7)

where, q∈ [symbol] ⁴ denotes a state vector, M(q)∈ [symbol] ^{4×4} denotes an inertial matrix, C(q, \dot{q})∈ [symbol] ^{4×4} denotes a Coriolis-centripetal matrix, G(q)∈ [symbol] ⁴ denotes a gravity vector, u∈ [symbol] ⁴ denotes a control input vector, F*∈ [symbol] ⁴ denotes a disturbance vector, and the specific expressions of these matrices and vectors are as follows:

$$q = {[ φ x {θ}_{1} {θ}_{2} ]}^{T} = {[ {q}_{1} {q}_{2} ]}^{T}$$

$$M ( q ) = ( \begin{matrix}{m}_{11} & {m}_{12} & {m}_{13} & {m}_{14} \\ {m}_{12} & {m}_{22} & {m}_{23} & {m}_{24} \\ {m}_{13} & {m}_{23} & {m}_{33} & {m}_{34} \\ {m}_{14} & {m}_{24} & {m}_{34} & {m}_{44}\end{matrix} ) = ( \begin{matrix}{M}_{11} & {M}_{12} \\ {M}_{12} & {M}_{22}\end{matrix} )$$

$$C ( q , \dot{q} ) = ( \begin{matrix}{c}_{11} & {c}_{12} & {c}_{13} & {c}_{14} \\ {c}_{21} & {c}_{22} & {c}_{23} & {c}_{24} \\ {c}_{31} & {c}_{32} & {c}_{33} & {c}_{34} \\ {c}_{41} & {c}_{42} & {c}_{43} & {c}_{44}\end{matrix} ) = ( \begin{matrix}{C}_{11} & {C}_{12} \\ {C}_{21} & {C}_{22}\end{matrix} )$$

$$G ( q ) = {[ 00 {m}_{p} g l {S}_{1} {C}_{2} {m}_{p} g l {C}_{1} {S}_{2} ]}^{T} = {[ {G}_{1} {G}_{2} ]}^{T}$$

$${u}^{*} = {[ {F}_{φ} {F}_{x} 00 ]}^{T} = {[ {u}_{1} {u}_{2} ]}^{T}$$

$${F}^{*} = {[ - {F}_{r φ} + {d}_{φ} - {F}_{rx} + {d}_{x} 00 ]}^{T} = {[ {F}_{1}^{*} {F}_{2}^{*} ]}^{T} where$$

$${q}_{1} = {[ φ x ]}^{T}$$

$${q}_{2} = {[ {θ}_{1} {θ}_{2} ]}^{T}$$

$${m}_{11} = {m}_{p} ( {S}_{1}^{2} {C}_{2}^{2} + {S}_{2}^{2} ) {l}^{2} + 2 {m}_{p} x l {C}_{2} {S}_{1} + J + ( {M}_{t} + {m}_{p} ) {x}^{2}$$

$${m}_{12} = - {m}_{p} l {S}_{2}$$

$${m}_{13} = - {m}_{p} {l}^{2} {C}_{1} {C}_{2} {S}_{2}$$

$${m}_{14} = {m}_{p} l ( {C}_{2} x + l {S}_{1} )$$

$${m}_{22} = {M}_{t} + {m}_{p}$$

$${m}_{23} = {m}_{p} l {C}_{1} {C}_{2}$$

$${m}_{24} = - {m}_{p} l {S}_{1} {S}_{2}$$

$${m}_{33} = {m}_{p} {l}^{2} {C}_{2}^{2}$$

$${m}_{34} = 0$$

$${m}_{44} = {m}_{p} {l}^{2}$$

$${M}_{11} = ( \begin{matrix}{m}_{11} & {m}_{12} \\ {m}_{12} & {m}_{22}\end{matrix} )$$

$${M}_{12} = ( \begin{matrix}{m}_{13} & {m}_{14} \\ {m}_{23} & {m}_{24}\end{matrix} )$$

$${M}_{22} = ( \begin{matrix}{m}_{33} & {m}_{34} \\ {m}_{34} & {m}_{44}\end{matrix} )$$

$${c}_{11} = 2 ( {M}_{c} + {m}_{p} ) x \dot{x}$$

$${c}_{12} = 2 {m}_{p} l {S}_{1} {C}_{2} \dot{φ}$$

$${c}_{13} = 2 {m}_{p} l {C}_{1} {C}_{2} x \dot{φ} + {m}_{p} {l}^{2} {S}_{21} {C}_{2}^{2} \dot{φ} + {m}_{p} {l}^{2} {S}_{1} {S}_{2} {C}_{2} {\dot{θ}}_{1}$$

$${c}_{14} = - {m}_{p} l {S}_{2} ( 2 \dot{φ} {S}_{1} + {\dot{θ}}_{2} ) x + {m}_{p} {l}^{2} {C}_{1}^{2} {S}_{22} \dot{φ} + 2 {m}_{p} {l}^{2} {C}_{1} {S}_{2}^{2} {\dot{θ}}_{1}$$

$${c}_{21} = - ( {M}_{t} + {m}_{p} ) x \dot{φ} - {m}_{p} l {S}_{1} {C}_{2} \dot{φ}$$

$${c}_{22} = 0$$

$${c}_{23} = - {m}_{p} l {S}_{1} {C}_{2} {\dot{θ}}_{1} - 2 {m}_{p} l {C}_{1} {S}_{2} {\dot{θ}}_{2}$$

$${c}_{24} = - {m}_{p} l {S}_{1} {C}_{2} {\dot{θ}}_{2} - 2 {m}_{p} l {C}_{2} \dot{φ}$$

$${c}_{31} = - {m}_{p} l {C}_{1} {C}_{2} ( x + l {S}_{1} {C}_{2} ) \dot{φ}$$

$${c}_{32} = 0$$

$${c}_{33} = - 2 {m}_{p} {l}^{2} {S}_{2} {C}_{2} {\dot{θ}}_{2}$$

$${c}_{34} = - 2 {m}_{p} {l}^{2} {C}_{1} {C}_{2}^{2} \dot{φ}$$

$${c}_{41} = {m}_{p} l ( x {S}_{1} {S}_{2} - l {C}_{1}^{2} {S}_{2} {C}_{2} ) \dot{φ}$$

$${c}_{42} = 2 {m}_{p} l {C}_{2} \dot{φ}$$

$${c}_{43} = 2 {m}_{p} {l}^{2} {C}_{1} {C}_{2}^{2} \dot{φ} + {m}_{p} {l}^{2} {S}_{2} {C}_{2} {\dot{θ}}_{1}$$

$${c}_{44} = 0$$

$${C}_{11} = ( \begin{matrix}{c}_{11} & {c}_{12} \\ {c}_{21} & {c}_{22}\end{matrix} )$$

$${C}_{12} = ( \begin{matrix}{c}_{13} & {c}_{14} \\ {c}_{23} & {c}_{24}\end{matrix} )$$

$${C}_{21} = ( \begin{matrix}{c}_{31} & {c}_{32} \\ {c}_{41} & {c}_{42}\end{matrix} )$$

$${C}_{22} = ( \begin{matrix}{c}_{33} & {c}_{34} \\ {c}_{43} & {c}_{44}\end{matrix} )$$

$${G}_{1} = {[ 00 ]}^{T}$$

$${G}_{2} = {[ {m}_{p} g l {S}_{1} {C}_{2} {m}_{p} g l {C}_{1} {S}_{2} ]}^{T}$$

$${u}_{1} = {[ {F}_{φ} {F}_{x} ]}^{T}$$

$${u}_{2} = {[ 00 ]}^{T}$$

$${F}_{1}^{*} = {[ - {F}_{r φ} + {d}_{φ} - {F}_{rx} + {d}_{x} ]}^{T}$$

$${F}_{2}^{*} = {[ 00 ]}^{T}$$

Eqs. (3)-(4) reflect the coupling relationship between the actuated jib/trolley motion and the unactuated payload swing motion, and the only solution to achieve rapid payload swing suppression and elimination is to take full advantage of this relationship. In order to facilitate the subsequent controller design, Equation (7) is decomposed into the following two equations:

M₁₁\ddot{q}₁+M₁₂\ddot{q}₂+C₁₁\dot{q}₁+C₁₂ \dot{q}₂=u₁+F*₁ (8)

M₁₂\ddot{q}₁+M₂₂\ddot{q}₂+C₂₁\dot{q}₁+C₂₂\dot{q}₂+G₂=F*₂ (9)

It can be readily concluded that |M₂₂|>0. Therefore, Equation (9) can be rewritten into the following form:

\ddot{q}₂=−M₂₂⁻¹M₁₂\ddot{q}₁−M₂₂⁻¹C₂₁\dot{q}₁−M₂₂⁻¹C₂₂\dot{q}₂−M₂₂⁻¹G₂+M₂₂⁻¹F*₂ (10)

By substituting Equation (10) into Equation (8), the following can be obtained:

M̅\ddot{q}₁+C̅₁\dot{q}₁+C̅₂\dot{q}₂=u₁+M₁₂M₂₂⁻¹G₂+F*₁−M₁₂M₂₂⁻¹F*₂ (11)

where

M̅=M₁₁−M₁₂M₂₂⁻¹M₁₂

C̅₁=C₁₁−M₁₂M₂₂⁻¹C₂₁

C̅₂=C₁₂−M₁₂−M₂₂⁻¹C₂₂

Then, a positioning error vector e is introduced as:

e=[φ−φ_{d} x−x_{d}]^{T}=[e_{φ}eₓ]^{T} (12)

where e_{φ} and eₓ denote positioning errors of a jib and a trolley, respectively.

Besides, a sliding mode surface vector s is constructed as:

s=e+λė=[s₁s₂]^{T} (13)

In this equation, λ∈ [symbol] ^{2×2}=diag(λ₁ λ₂) denotes a positive definite diagonal control matrix.

Next, an error dynamic model of the system solved from Eqs. (11)-(13) is as follows:

M̅λ⁻¹\dot{s}=u₁+X₁+X₂ (14)

where X₁ denotes a bounded measurable vector, X₂ denotes a lumped disturbance vector, and the specific expressions of these vectors are as follows:

X₁=−C̅₁\dot{q}₁−C̅₂\dot{q}₂+M̅λ⁻¹ė+M₁₂M₂₂⁻¹G₂

X₂=F*₁−M₁₂M₂₂⁻¹F*₂∥X₁∥≤N (15)

where N denotes a bounded constant.

It can be readily concluded that ∥M̅∥≠0. Therefore, Equation (14) can be further simplified as:

\dot{s}=u*₁+X*₁+C*₂ (16)

where

u*₁=λM̅⁻¹u₁X*₁=λM̅⁻¹X₁X*₂=λM̅⁻¹X₂ (18)

In this Equation, u*₁, X*₁, and X*₂ denote a control input vector, a bounded measurable vector and a lumped disturbance vector which are newly constructed, respectively.

Assumption 1: in light of the fact that a payload is always beneath a jib/trolley during actual operation, the following reasonable assumption is made:

$$\vert {θ}_{1} \vert < \frac{π}{2} , \vert {θ}_{2} \vert < \frac{π}{2} \qquad ( 18 )$$

Assumption 2: regarding tower crane systems, a lumped disturbance vector X*₂ and its first derivative with respect to time \dot{X}*₂ are both bounded, and in addition, X*₂, d_{φ}, dₓ converge to 0 as time approaches infinity, which is mathematically expressed as:

$$‖ {X}_{2}^{*} ‖ < β , ‖ {\dot{X}}_{2}^{*} ‖ < α , {lim}_{t \to ∞} {X}_{2}^{*} = 0 , {lim}_{t \to ∞} {d}_{φ} = 0 , {lim}_{t \to ∞} {d}_{x} = 0 \qquad ( 19 )$$

where β and α denote upper bounds of X*₂ and \dot{X}*₂ respectively.

Note 1: Since unknown disturbances d_{φ},dₓ are composed of internal disturbances and external disturbances, the system parameters and the friction-related coefficients adopted in the present embodiment refer to their nominal values.

S2: Control objective

The ultimate goal of controller design is to transport the payload to a target position quickly and steadily in the presence of uncertain/unknown dynamics and external disturbances. However, as mentioned above, it is impossible to directly control the swing of the payload due to the inherent underactuation of the crane system.

Therefore, the control objective is divided into two parts:
1) Positioning: drive a jib or trolley to its target angle/position, which is mathematically expressed as:

$${lim}_{t \to ∞} φ = {φ}_{d} , {lim}_{t \to ∞} x = {x}_{d} \qquad ( 20 )$$

2) Swing elimination: in the meanwhile, payload swing is inhibited and eliminated, which is expressed as:

$${lim}_{t \to ∞} {θ}_{1} = 0 , {lim}_{t \to ∞} {θ}_{2} = 0 \qquad ( 21 )$$

S3: Main results

In this embodiment, the overall framework designed for the DESMC method is given, and a nonlinear disturbance observer is constructed to accurately estimate lumped disturbance. Based on the estimated disturbance information, a new DEI is introduced to judge the pros and cons of disturbance acting on the tower crane system. Afterwards, by making full use of the constructed DEI and the estimated disturbance information, the whole process from design to stability analysis for a DESMC method is achieved.

S3.1: Design of nonlinear disturbance observer

First, an observed error vector \tilde{X}*₂ is defined as:

\tilde{X}*₂=X*₂−\hat{X}*₂ (22)

where \hat{X}*₂ denotes an estimated vector of X*₂.

Next, according to the structure of the error dynamic model (16) of a tower crane system, the auxiliary function Γ₁ in the following form is constructed:

\dot{Γ}₁=−LΓ₁+L(−u*₁−X*₁−Γ₂) (23)

where L∈ [symbol] ^{2×2}=diag(L₁ L₂) denotes a positive definite diagonal observation gain matrix, and the auxiliary function Γ₂ is specifically expressed as:

Γ₂=Ls (24)

Therefore, an estimated vector of X 2 can be constructed as follows:

\hat{X}*₂=Γ₁+Γ₂ (25)

Theorem 1: by using the nonlinear disturbance observer designed according to Eqs. (23)-(25), the estimated disturbance vector and observed error vector are constrained within the following range:

∥\hat{X}*₂∥≤P₁, ∥\tilde{X}*₂∥≤P₂ (26)

where P₁ and P₂ denote upper bounds of \hat{X}*₂ and \tilde{X}*₂, respectively, and besides, \tilde{X}*₂ converges to 0 as time approaches infinity, which is mathematically expressed as:

$${lim}_{t \to ∞} {\tilde{X}}_{2}^{*} = 0 \qquad ( 27 )$$

Proof: it follows from Eqs. (16) and (23)-(25) that:

$$\begin{matrix}{\dot{\hat{X}}}_{2}^{*} = {\dot{Γ}}_{1} + {\dot{Γ}}_{2} \\ = - L {Γ}_{1} + L ( {X}_{2}^{*} - \dot{s} - {Γ}_{2} ) + L \dot{s} \\ = - L {Γ}_{1} + L ( - {u}_{1}^{*} - {X}_{2}^{*} - {Γ}_{2} ) + L \dot{s} \\ = - L {Γ}_{1} + L ( {X}_{2}^{*} - \dot{s} - {Γ}_{2} ) + L \dot{s} \\ = - L {\hat{X}}_{2}^{*} + L {X}_{2}^{*}\end{matrix} \qquad ( 28 )$$

Solving Equation (28) may lead to the following conclusion:

$${\hat{X}}_{2}^{*} = {\hat{X}}_{2}^{*} ( 0 ) {e}^{- Lt} + {e}^{- Lt} {\int }_{0}^{t} {LX}_{2}^{*} {e}^{La} da \leq {\hat{X}}_{2}^{*} ( 0 ) {e}^{- Lt} + {e}^{- Lt} L β {\int }_{0}^{t} {e}^{La} da \leq {\hat{X}}_{2}^{*} ( 0 ) {e}^{- Lt} + β ⇒ ‖ {\hat{X}}_{2}^{*} ‖ \leq ‖ {\hat{X}}_{2}^{*} ( 0 ) ‖ + β \qquad ( 29 )$$

Equation (28) is also followed by:

$${\tilde{X}}_{2}^{*} = {\tilde{X}}_{2}^{*} ( 0 ) {e}^{- Lt} + {e}^{- Lt} {\int }_{0}^{t} {\dot{X}}_{2}^{*} {e}^{La} da \leq {\tilde{X}}_{2}^{*} ( 0 ) {e}^{- Lt} + {e}^{- Lt} α {\int }_{0}^{t} {e}^{La} da \leq {\tilde{X}}_{2}^{*} ( 0 ) {e}^{- Lt} + {L}^{- 1} α ⇒ ‖ {\tilde{X}}_{2}^{*} ‖ \leq ‖ {\tilde{X}}_{2}^{*} ( 0 ) ‖ + ‖ {L}^{- 1} ‖ α \qquad ( 30 )$$

According to Equation (30), as time approaches infinity, the observed error vector can be calculated as:

$${lim}_{t \to ∞} ‖ {\tilde{X}}_{2}^{*} ‖ \leq ‖ {L}^{- 1} ‖ α \qquad ( 31 )$$

Based on the setting ∥L∥»α of the present embodiment, the following conclusion can be drawn:

$${lim}_{t \to ∞} ‖ {\tilde{X}}_{2}^{*} ‖ = 0 \to {lim}_{t \to ∞} ‖ {\hat{X}}_{2}^{*} ‖ = 0 \qquad ( 32 )$$

S3.2: Definition of DEI

Time-varying disturbance may impose significant effects on the transient control performance of a tower crane system. If the direction of disturbance is consistent with the desired direction of movement, the disturbance may be able to improve the control performance. Therefore, it is essential to conduct an in-depth study on the relationship between the disturbance effect and the stability/control performance of a controlled system. A definition of the DEI is given herein.

Definition 1: for the error model (16) of the tower crane system, the DEI is defined as:

X=sgn(s∘\hat{X}*₂)=[X₁ X₂]^{T}∈ [symbol] ² (33)

In this Equation, ∘ denotes a product of elements, and on this basis, the disturbance effect for the model introduced into the error system (16) is as follows:

$$\{ \begin{matrix}{χ}_{i} < 0 : disturbance effect is negative \\ {χ}_{i} < 0 : disturbance effect is postive \\ {χ}_{i} = 0 : disturbance effect is nill , i = 1 , 2\end{matrix} \qquad ( 34 )$$

As described in Definition 1, apart from negative effects that the disturbance may impose on the tower crane system, it also has positive effects. If xᵢ=0, it indicates that disturbance imposes no effect on the system; and if xᵢ>0 or xᵢ<0, it indicates that disturbance is detrimental or beneficial, respectively. Considering that Definition 1 is given depending on whether the symbol of the disturbances is consistent with the desired movement, it is necessary to improve the control performance of the system by employing beneficial disturbances.

S3.3: Design and stability analysis for DESMC method

Firstly, non-negative Lyapunov candidate function V(t) is defined as follows:

V(t)=½s^{T}s (35)

Differentiating Equation (35) with respect to time, and substituting Equation (16) into the resulting equation, it is derived that:

\dot{V}(t)=s^{T}\dot{s}=s^{T}(u*₁+X*₁+X*₂) (36)

Construct a DESMC method according to the structure of Equation (36), which is expressed as:

u*₁=−kₚs−kₛ sgn(s)−∥kᵤq₂∥s−\hat{X}*₂∘Θ(χ) 37)

where kₚ=diag(kₚ₁, kₚ₂) and kₛ=diag(kₛ₁, kₛ₂) denote positive definite control gain matrices, sgn(s)=[sgn(s₁) sgn(s₂)]^{T}, Θ(χ)=diag[Θ(χ₁), Θ(χ₂)], where Θ(χᵢ), i=1, 2 is expressed as follows:

$$Θ ( {χ}_{i} ) = \{ \begin{matrix}1 , & if {χ}_{i} \geq 0 \\ 0 , & if {χ}_{i} < 0\end{matrix} , i = 1 , 2 \qquad ( 38 )$$

From Eqs. (17) and (37), it is easy to derive the actual input vector as:

u₁=λ⁻¹M̅[−kₚs−kₛ sgn(s)−∥kᵤq₂∥s−\hat{X}*₂∘Θ(χ)] (39)

Theorem 2: the proposed DESMC method (39) can drive a jib and a trolley to a desired slew angle and a desired target displaced position, respectively, while eliminating payload swing angles, which is expressed as:

$${lim}_{t \to ∞} {[ φ x {θ}_{1} {θ}_{2} ]}^{T} = {[ {φ}_{d} {x}_{d} 00 ]}^{T} \qquad ( 40 )$$

$${lim}_{t \to ∞} {[ \dot{φ} \dot{x} {\dot{θ}}_{1} {\ddot{θ}}_{2} ]}^{T} = {[ 0000 ]}^{T}$$

Proof: by substituting Equation (37) into Equation (36), the following is obtained:

$$\begin{matrix}\dot{V} ( t ) = {s}^{T} ( - {k}_{p} s - {k}_{s} sgn ( s ) - ‖ {k}_{u} {q}_{2} ‖ s + {X}_{1}^{*} + ( {X}_{2}^{*} - {\hat{X}}_{2}^{*} ∘ Θ ( χ ) ) ) \\ = - {s}^{T} {k}_{p} s - {s}^{T} ‖ {k}_{u} {q}_{2} ‖ s - {k}_{s} ‖ s ‖ + {s}^{T} {X}_{1}^{*} + {s}^{T} ( {X}_{2}^{*} - {\hat{X}}_{2}^{*} ∘ Θ ( χ ) ) \\ = - {s}^{T} {k}_{p} s - {s}^{T} ‖ {k}_{u} {q}_{2} ‖ s - {k}_{s} ‖ s ‖ + {s}^{T} {X}_{1}^{*} + \\ ( {X}_{2}^{*} - {\hat{X}}_{2}^{*} ) + ( {\hat{X}}_{2}^{*} - {\hat{X}}_{2}^{*} ∘ Θ ( χ ) ) \\ = - {s}^{T} {k}_{p} s - {s}^{T} ‖ {k}_{u} {q}_{2} ‖ s - {k}_{s} ‖ s ‖ + {s}^{T} {X}_{1}^{*} + {s}^{T} {\tilde{X}}_{2}^{*} + Ω \leq \\ - {s}^{T} {k}_{p} s - {s}^{T} ‖ {k}_{u} {q}_{2} ‖ s - {k}_{s} ‖ s ‖ + ‖ s ‖ + ‖ s ‖ {P}_{2} + Ω \leq \\ - {s}^{T} {k}_{p} s - {s}^{T} ‖ {k}_{u} {q}_{2} ‖ s - ( {k}_{s} - N - {P}_{2} ) ‖ s ‖ + Ω\end{matrix} \qquad ( 41 )$$

where Ω=s^{T}(\hat{X}*₂−\hat{X}*₂∘Θ(χ)) is an auxiliary function, then Ω proves to be non-positive, and by expanding Ω, Ω=Σᵢ₌₁²sᵢ(\hat{X}*₂ᵢ−\hat{X}*₂ᵢΘ(χᵢ)) can be obtained, which is analyzed based on the following two cases.
1) Case 1: χᵢ≥0, i=1, 2, where in this case, disturbance is harmful/invalid. Therefore, it is required to eliminate such disturbance. At this moment, Θ(χᵢ)=1, which is followed by sᵢ(\hat{X}*₂ᵢ−\hat{X}*₂ᵢΘ(χᵢ))=0→Ω=0.
2) Case 2: χᵢ<0, i=1, 2, where in this case, disturbance is beneficial. At this moment, the relationship sᵢ\hat{X}*₂ᵢ<0 always holds, and therefore it is required to retain disturbance, from which it can be concluded that Θ(χᵢ)=0, and the following can be deduced:

sᵢ(\hat{X}*₂ᵢ−\hat{X}*₂ᵢΘ(χᵢ))=sᵢ\hat{X}*₂ᵢ<0→Ω<0

In general, the following conclusion can be drawn:

Ω=s^{T}(\hat{X}*₂−\hat{X}*₂∘Θ(χ))<0 (42)

Eqs. (41) and (42) are followed by:

\dot{V}(t)≤−s^{T}kₚs−s^{T}∥kᵤq₂∥s−(kₛ−N−P₂)∥s∥≤0 (43)

This shows that the controlled system is Lyapunov stable, and the Lyapunov candidate function V(t) is bounded, in the sense that:

V(t)∈L_{∞}⇒s∈L_{∞} (44)

Besides, a sliding mode surface converges to 0, in the sense that:

$${lim}_{t \to ∞} s = 0 \to {lim}_{t \to ∞} {s}_{i} = 0 , i = 1 , 2 \qquad ( 45 )$$

In case of s=0, the following can be obtained according to the definition of the sliding mode surface (13):

eⱼ+λᵢėⱼ=0, j=φ, x (46)

It can be deduced from the calculation equation (46) that:

$${e}_{j} = {c}_{i} {e}^{- \frac{1}{{λ}_{i}} t} , \dot{e} = - \frac{1}{{λ}_{i}} {c}_{i} {e}^{- \frac{1}{{λ}_{i}} t} , j = φ , x \qquad ( 47 )$$

It follows from Equation (47) that:

$${lim}_{t \to ∞} {e}_{ϕ} = 0 , {lim}_{t \to ∞} {\dot{e}}_{ϕ} = 0 , {lim}_{t \to ∞} {e}_{x} = 0 , {lim}_{t \to ∞} {\dot{e}}_{x} = 0 ⇒ {lim}_{t \to ∞} φ = {φ}_{d} , {lim}_{t \to ∞} \dot{φ} = 0 , {lim}_{t \to ∞} x = {x}_{d} , {lim}_{t \to ∞} \dot{x} = 0 , {lim}_{t \to ∞} \ddot{φ} = 0 , {lim}_{t \to ∞} \ddot{x} = 0 , {lim}_{t \to ∞} {F}_{r φ} = 0 , {lim}_{t \to ∞} {F}_{rx} = 0 \qquad ( 48 )$$

Eqs. (26), (39) and (44) are followed by:

u₁∈L_{∞}⇒F_{φ}, Fₓ∈L_{∞} (49)

From Eqs. (45), (39) and (32) as well as conclusion in Assumption 2, it can be readily concluded that:

$${lim}_{t \to ∞} {u}_{1} = 0 ⇒ {lim}_{t \to ∞} {F}_{φ} = 0 , {lim}_{t \to ∞} {F}_{x} = 0 \qquad ( 50 )$$

By substituting Equation (48) into Eqs. (3) and (4), respectively, the following conclusion may be drawn:

lC₂\ddot{θ}₁=2l\dot{θ}₁S₂\dot{θ}₂−gS₁ (51)

l\ddot{θ}₂=−l\dot{θ}₁²S₂C₂−gC₁S₂ (52)

From Eqs. (48), (50), (19) and (2), it can be concluded that:

C₁C₂\ddot{θ}₁−C₁S₂\dot{θ}₁\dot{θ}₂−S₁C₂\dot{θ}₁²−S₁S₂\ddot{θ}₂−C₁S₂\dot{θ}₁\dot{θ}₂−C₂S₁\dot{θ}₂²=0 (53)

By multiplying both ends of Equation (53) by l, it can be concluded that:

lC₁C₂\ddot{θ}₁−lC₁S₂\dot{θ}₁\dot{θ}₂−lS₁C₂\dot{θ}₁²−lS₁S₂\ddot{θ}₂−lC₁S₂\dot{θ}₁\dot{θ}₂−lC₂S₁\dot{θ}₂²=0 (54)

By substituting the conclusions of Eqs. (51) and (52) into Equation (54), and after some tedious operations, the following can be deduced:

gC₁S₁C₂²+lS₁C₂³\dot{θ}₁²+lC₂S₁\dot{θ}₂²=0 (55)

where, the characteristic of C₂²+S₂²=1 is used in the process of derivation. According to Assumption 1, the relationship C₂>0 always holds. Therefore, by dividing both ends of Equation (54) by C₂, the following can be deduced:

S₁(gC₁C₂+lC₂²\dot{θ}₁²+l\dot{θ}₂²)=0 (56)

Next, following the conclusions C₁>0 and C₂>0 (see Assumption 1), it can be concluded that gC₁C₂+lC₂²\dot{θ}₁²+l\dot{θ}₂²>0 in Equation (56) always holds. Therefore, to ensure Equation (56) always holds, the following result is derived:

S₁=0⇒θ₁=0\dot{θ}₁=0,\ddot{θ}₁=0 (57)

By substituting conclusions in Eqs. (19), (48), (50) and (57) into Equation (1), it can be concluded that:

mₚlx_{d}C₂\ddot{θ}₂−mₚlx_{d}S₂\dot{θ}₂²=0 (58)

By integrating both ends of Equation (58) with respect to time, it can be concluded that:

mₚlx_{d}C₂\dot{θ}₂=a₁ (59)

where a₁ denotes a to-be-determined constant.

A time inteual of Equation (59) can be calculated as:

$${S}_{2} = \frac{{a}_{1}}{{m}_{p} l {x}_{d}} t + {a}_{2} \qquad ( 60 )$$

where a₂ is a constant. If a₁≠0, then when t→∞:

S₂→∞ (61)

which contradicts S₂∈L_{∞}. Therefore, it can be concluded that a₁=0, and the following can be further deduced from Equation (60):

S₂=a₂→θ₂=arcsin(a₂)→\dot{θ}₂=0, \ddot{θ}₂=0 (62)

By substituting the conclusions of Eqs. (57) and (62) into Equation (52), the following can be deduced:

gC₁S₂=0→S₂=0→θ₂=0 (63)

The conclusion of Assumption 1 is used in the process of derivation.

According to the conclusions in Eqs. (48), (58) and (63), Theorem 2 can be proved.

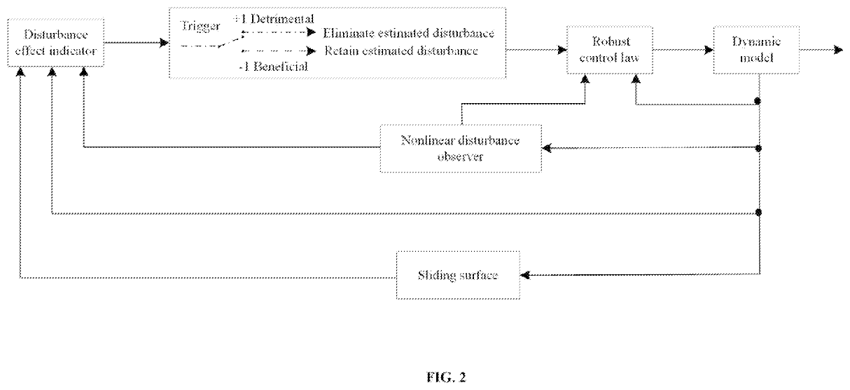

Next, in order to better understand the design flow of the proposed control method, a schematic diagram of the method is given, as shown in FIG. 2.

S3. Simulation results and analysis In order to test the superior control performance and satisfactory robustness of the proposed DESMC method, two groups of numerical simulations are carried out by using MATLAB/SIMULINK. To be more precise, in Simulation 1, the proposed control method is compared with PD control method and adaptive control method to better verify the excellent control performance of the proposed control method; in Simulation 2, the uncertainty of system parameters and different external disturbance are considered to verify that the proposed control method has good robustness.

TABLE 2
Control gains

| Controller | Control gains |
|---|---|
| PD Controller | k_{pφ} = 15, k_{dφ} = 20, kₚₓ = 7, k_{dx} = 10 |
| Adaptive controller | k_{pφ} = 13.5, k_{dφ} = 25, kₚₓ = 7, k_{dx} = 12, |
| | k_{sφ} = 100, kₛₓ = 10 |
| Proposed controller | k_{pφ} = 16, k_{dφ} = 25, kₚₓ = 10, k_{dx} = 13.2, |
| | k_{sφ} = 40, |
| | kₛₓ = 10, L = diag(100 100), |
| | λ = diag(10 15) |

Simulation 1: in this group, the PD control method and adaptive control method are selected as control methods to better highlight the excellent control performance of the proposed control method. With cut-and-trial, control gains of the three control methods are shown in Table 2.

In this study, parameters of the tower crane system are set as follows:

Mₜ =3.5 kg, mₚ=1 kg, l=0.6 m, F_{rφ1}=4.4, F_{rφ2}=−0.5, ρ_{φ}=100, Fᵣₓ₁=4.4, Fᵣₓ₂=−0.5, ρₓ=100

For the sake of retaining generality, the initial slew angle of the jib, the initial trolley displacement, and the initial payload swing angle are set as 0, in the sense that:

φ(0)=0°, x(0)=0 m, θ₁(0)=0°, θ₂(0)=0°

In addition, the desired jib slew angle and desired position of trolley are set as follows:

φ_{d}=45°, x_{d}=1 m

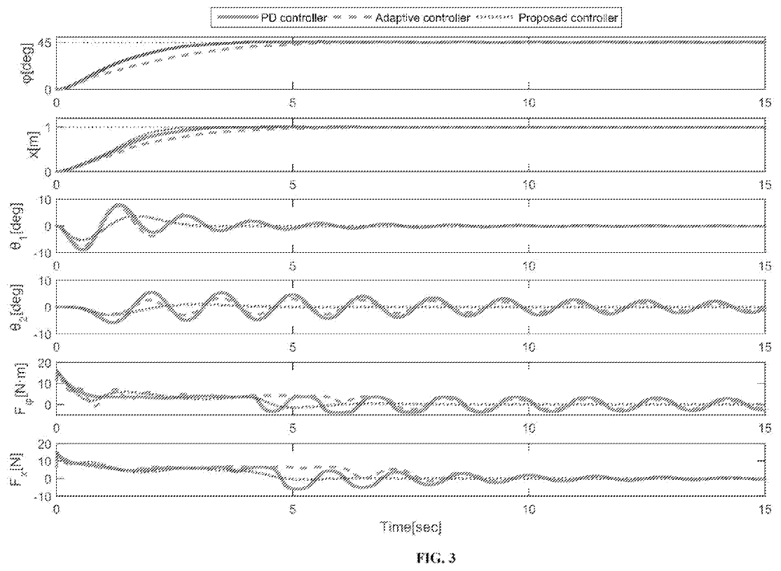

Simulation results of PD control method, adaptive control method and proposed control method are shown in FIG. 3, and corresponding quantization results are given in Table 3, including the following four performance indicators:
1) Positioning errors of jib/trolley: Δφ and Δx;
2) Maximum payload swing angles: θ₁ₘₐₓ and θ₂ₘₐₓ;
3) Residual payload swing angles: θ₁ᵣₑₛ and θ₂ᵣₑₛ, defined as maximum payload swing angles after t=6 s;
4) Energy consumption: ∫₀¹⁵F_{φ}²(t)dt and ∫₀¹⁵Fₓ²(t)dt.

As can be seen from FIG. 3 and Table 3, under the condition of similar positioning errors (respectively falling within the range of 0.02° and 0.001 m) and similar transport times (falling within the range of 6 s), the payload swing angles (θ₁ₘₐₓ: 5.3028°, θ₂ₘₐₓ: 2.8654°; θ₁ᵣₑₛ: 0.0008°; θ₂ᵣₑₛ: 0.0006°) in the proposed DESMC method are much smaller than the swing angles (θ₁ₘₐₓ: 8.9912°, θ₂ₘₐₓ: 5.7958°; θ₁ᵣₑₛ: 1.1583°; θ₂ᵣₑₛ: 4.0565°) in the PD control method and the swing angles (θ₁ₘₐₓ: 7.8383°, θ₂ₘₐₓ: 3.4531°; θ₁ᵣₑₛ: 0.9039°; θ₂ᵣₑₛ: 2.6509°) in the adaptive control method. Moreover, in the PD control method and the adaptive control method, the payload still swings back and forth even after the jib and trolley stop running, while the payload is almost static in the control method proposed in this embodiment. In addition, energy consumption in the proposed DESMC method is much lower than that in the above two control methods. All these simulation results show that the proposed control method has excellent control performance.

TABLE 3
Quantitative results for simulation group 1

| | Δφ | Δx | θ₁ₘₐₓ | θ₂ₘₐₓ | θ₁ᵣₑₛ | θ₂ᵣₑₛ | ∫₀¹⁵F_{φ}²(t)dt | ∫₀¹⁵Fₓ²(t)dt |
|---|---|---|---|---|---|---|---|---|
| Controller | (°) | (m) | (°) | (°) | (°) | (°) | (N² · m² · s) | (N² · s) |
| PD | 0.1518 | 0.0008 | 8.9912 | 5.7958 | 1.1583 | 4.0565 | 178.1228 | 256.0058 |
| controller | | | | | | | | |
| Adaptive | 0.0901 | 0.0005 | 7.8383 | 3.4531 | 0.9039 | 2.6509 | 171.7246 | 304.8559 |
| controller | | | | | | | | |
| Proposed | 0.0003 | 0.0001 | 5.3028 | 2.8654 | 0.0008 | 0.0006 | 109.5841 | 174.8429 |
| controller | | | | | | | | |

Simulation group 2: In this group, the robustness of the proposed control method will be further verified. For this purpose, the following two cases are considered:

Case 1: uncertainty system parameters: payload mass mₚ, cable length l, and friction-related coefficients F_{rφ1} and Fᵣₓ₁ are changed to 2 kg, 0.7 m, 6 and 7.6, respectively, while the control gain in the proposed control method are kept the same as those in simulation group 1.

Case 2: external disturbances: in order to simulate external disturbances, such as a sudden gust of wind, the initial payload swing angle θ₁(0) is set to be 2°, and when 7 s<t<8 s, sinusoidal disturbance with an amplitude of 3° and a cycle of 1 s is applied onto a payload swing angle θ₂.

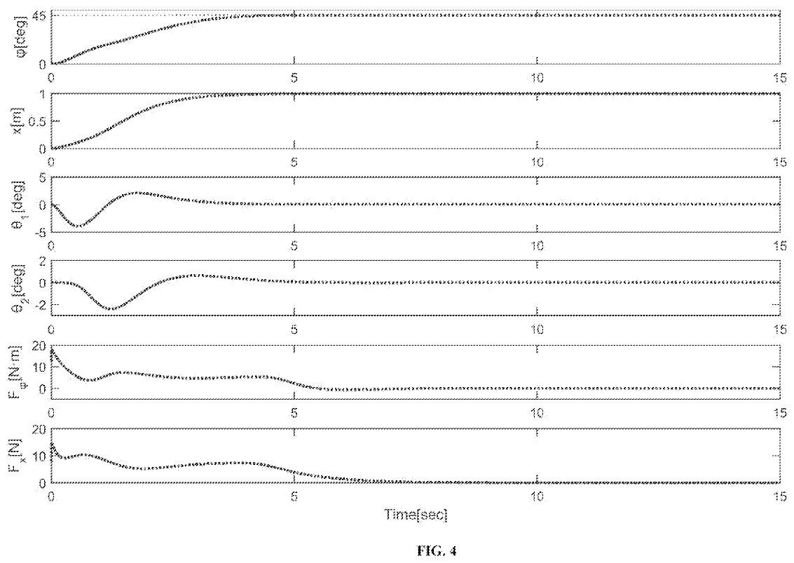

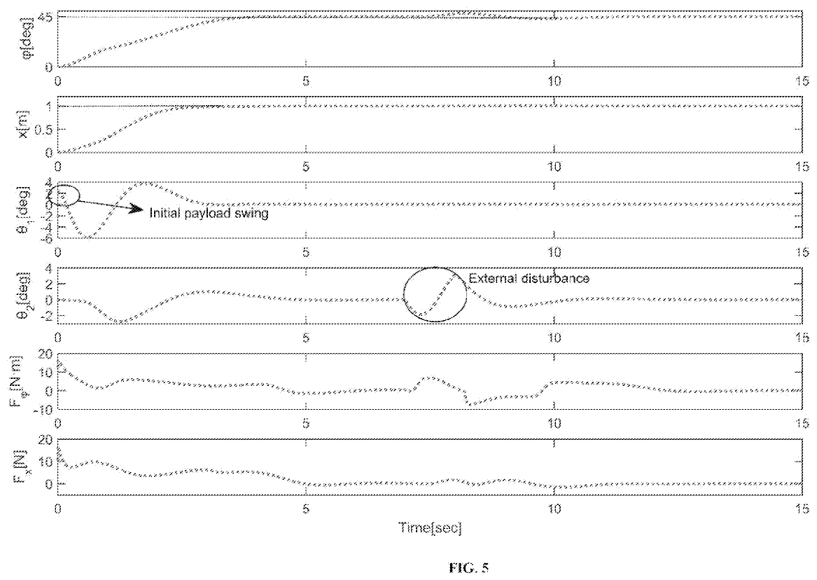

Simulation results for Case 1 are shown in FIG. 4. By comparison to FIG. 3, even in case of huge difference between an actual value and a nominal value of system parameters, the proposed control method can still ensure desired control performance. For example, parameter variation of the system has almost no impact on system positioning and payload swing elimination. In addition, as can be seen from FIG. 5, the proposed control method can quickly eliminate different external disturbance through the forward and backward movement of the jib and the trolley. Through the above analysis, it can be concluded that the proposed DESMC method has stronger robustness.

### Embodiment 2

Embodiment 2 of the present disclosure provides a DESMC control system for 4-DOF tower crane systems, including:

a data acquisition module, which is configured to acquire parameter data and operating state data of the 4-DOF tower crane systems;

a disturbance judgment module, which is configured to conduct, based on the acquired data, disturbance estimation by using a preset nonlinear disturbance observer, and conduct judgment on beneficial disturbance and detrimental disturbance according to a preset DEI; and

a sliding mode control module, which is configured to add the beneficial disturbance to a preset sliding mode controller, remove the detrimental disturbance, drive a jib and a trolley to a desired slew angle and a desired target displaced position, respectively, and set a payload swing angle to be 0 or within a preset range.

Given that the operating method of the system is the same as the DESMC method for 4-DOF tower crane systems provided by Embodiment 1, the details are not repeated herein.

### Embodiment 3

Embodiment 3 of the present disclosure provides a medium storing a program, where the program, when executed by a processor, implements steps of the DESMC method for 4-DOF tower crane systems as described in Embodiment 1 of the present disclosure.

### Embodiment 4

Embodiment 4 of the present disclosure provides an electronic device, including a memory, a processor, and a program stored in the memory and executable on the processor, where the processor, when executing the program, implements steps of the DESMC method for 4-DOF tower crane systems as described in Embodiment 1 of the present disclosure.

Those skilled in the art should understand that the embodiments of the present disclosure may be provided as a method, a system or a computer program product. Therefore, the present disclosure may use a form of hardware examples, software examples, or examples with a combination of software and hardware. Moreover, the present disclosure may use a form of a computer program product that is implemented on one or more computer-usable storage media, including but not limited to a magnetic disk memory and a compact disc read-only memory (CD-ROM), which include computer-usable program code.

The present disclosure is described with reference to the flowcharts and/or block diagrams of the method, the device (system) and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

A person of ordinary skill in the art may understand that all or some of the procedures in the methods of the foregoing embodiments may be implemented by a computer program instructing related hardware. The program may be stored in a computer readable storage medium. When the program is executed, the procedures in the embodiments of the foregoing methods may be performed. The storage medium may be a magnetic disk, an optical disk, a read-only memory (ROM) or a random access memory (RAM), etc.

The foregoing is merely illustrative of the preferred embodiments of the present disclosure and is not intended to limit the present disclosure, and various changes and modifications can be made to the present disclosure by those skilled in the art. Any modifications, equivalent replacements, improvements, etc. made within the spirit and principle of the present disclosure shall be included within the protection scope of the present disclosure.

What is claimed is:

1. A disturbance employment-based sliding mode control (DESMC) method for four-degrees-of-freedom (4-DOF) tower crane systems, comprising the following steps:
acquiring parameter data and operating state data of the 4-DOF tower crane systems;
conducting, based on the acquired data, disturbance estimation by using a preset nonlinear disturbance observer, and conducting judgment on beneficial disturbance and detrimental disturbance according to a preset disturbance effect indicator (DEI); and
adding the beneficial disturbance to a preset sliding mode controller, removing the detrimental disturbance, driving a jib and a trolley to a desired slew angle and a desired target displaced position, respectively, and setting a payload swing angle to be 0 or within a preset range.

2. The DESMC method for 4-DOF tower crane systems according to claim 1, wherein:
an absolute value of a payload swing angle is less than 90°.

3. The DESMC method for 4-DOF tower crane systems according to claim 1, wherein:
a lumped disturbance vector and disturbances comprising internal disturbances and external disturbances both converge to 0 as time approaches infinity.

4. The DESMC method for 4-DOF tower crane systems according to claim 1, wherein:
an observed error vector is a difference between a lumped disturbance vector and a lumped disturbance estimation vector, the lumped disturbance estimation vector being a sum of a first auxiliary function and a second auxiliary function;
the first auxiliary function is as follows:
\dot{Γ}₁=−LΓ₁+L(−u*₁−X*₁−Γ₂)
the second auxiliary function is as follows:
Γ₂=Ls
wherein L denotes a positive definite diagonal observation gain matrix, X*₁ denotes a bounded measurable vector, u*₁ denotes a control input vector, and s denotes a sliding mode surface vector.

5. The DESMC method for 4-DOF tower crane systems according to claim 1, wherein:
the DEI is as follows:
χ=sgn(s∘\hat{X}*₂)=[χ₁ χ₂]^{T}∈ [symbol] ²
wherein s denotes a sliding mode surface vector, \hat{X}*₂ denotes a lumped disturbance vector, and ∘ denotes a product of elements.

6. The DESMC method for 4-DOF tower crane systems according to claim 1, wherein:
an actual input of sliding mode control is as follows:
u₁=λ⁻¹M̅[−kₚs−kₛ sgn (s)−∥kᵤq₂∥s−\hat{X}*₂∘Θ(χ)]
wherein, λ denotes a positive definite diagonal control matrix, M̅=M₁₁−M₁₂M₂₂⁻¹M₁₂, kₚ=diag(kₚ₁, kₚ₂) , and kₛ=diag(kₛ₁, Kₛ₂) denote positive definite control gain matrices, and s denotes a sliding mode surface vector;
sgn(s)=[sgn (s₁) sgn(s₂)]^{T}, Θ(χ)=diag[Θ(χ₁), Θ(χ₂)],
$$Θ ( {χ}_{i} ) = \{ \begin{matrix}1 , & if {χ}_{i} \geq 0 \\ 0 , & if {χ}_{i} < 0\end{matrix} ,$$
i=1,2, q₂=[θ₁ θ₂]^{T}, θ₁θ₂ denote payload swing angles.

7. The DESMC method for 4-DOF tower crane systems according to claim 4, wherein:
the sliding mode surface vector is as follows:
s=e+λė=[s₁ s₂]^{T}
wherein λ denotes the positive definite diagonal control matrix, and e denotes a positioning error vector.

8. The DESMC method for 4-DOF tower crane systems according to claim 5, wherein:
the sliding mode surface vector is as follows:
s=e+λė=[s₁ s₂]^{T}
wherein λ denotes the positive definite diagonal control matrix, and e denotes a positioning error vector.

9. The DESMC method for 4-DOF tower crane systems according to claim 6, wherein:
the sliding mode surface vector is as follows:
s=e+λė=[s₁ s_{2]}^{T}
wherein λ denotes the positive definite diagonal control matrix, and e denotes a positioning error vector.

10. A DESMC system for 4-DOF tower crane systems, comprising:
a data acquisition module, which is configured to acquire parameter data and operating state data of the 4-DOF tower crane systems;
a disturbance judgment module, which is configured to conduct, based on the acquired data, disturbance estimation by using a preset nonlinear disturbance observer, and conduct judgment on beneficial disturbance and detrimental disturbance according to a preset DEI; and
a sliding mode control module, which is configured to add the beneficial disturbance to a preset sliding mode controller, remove the detrimental disturbance, drive a jib and a trolley to a desired slew angle and a desired target displaced position, respectively, and set a payload swing angle to be zero or within a preset range.

11. A medium storing a program, wherein the program, when executed by a processor, implements steps of the DESMC method for 4-DOF tower crane systems according to claim 1.

12. The medium storing a program according to claim 11, wherein:
an absolute value of a payload swing angle is less than 90°.

13. The medium storing a program according to claim 11, wherein:
a lumped disturbance vector and disturbances comprising internal disturbances and external disturbances both converge to 0 as time approaches infinity.

14. The medium storing a program according to claim 11, wherein:
an observed error vector is a difference between a lumped disturbance vector and a lumped disturbance estimation vector, the lumped disturbance estimation vector being a sum of a first auxiliary function and a second auxiliary function;
the first auxiliary function is as follows:
\dot{Γ}₁=−LΓ₁+L(−u*₁−X*₁−Γ₂)
the second auxiliary function is as follows:
Γ₂=Ls
wherein L denotes a positive definite diagonal observation gain matrix, X*₁ denotes a bounded measurable vector, u*₁ denotes a control input vector, and s denotes a sliding mode surface vector.

15. The medium storing a program according to claim 11, wherein:
the DEI is as follows:
χ=sgn(s∘\hat{X}*₂)=[χ₁ χ₂]^{T}∈ [symbol] ²
wherein s denotes a sliding mode surface vector, \hat{X}*₂ denotes a lumped disturbance vector, and ∘ denotes a product of elements.

16. The medium storing a program according to claim 11, wherein:
an actual input of sliding mode control is as follows:
u₁=λ⁻¹M̅[−kₚs−kₛ sgn(s)−∥kᵤq₂∥s−\hat{X}*₂∘Θ(χ)]
wherein, λ denotes a positive definite diagonal control matrix, M̅=M₁₁−M₁₂M₂₂⁻¹M₁₂, kₚ=diag(kₚ₁, kₚ₂), and kₛ=diag(kₛ₁, Kₛ₂) denote positive definite control gain matrices, and s denotes a sliding mode surface vector; sgn(s)=[sgn(s₁) sgn(s₂)]^{T}, Θ(χ)=diag [Θ(χ₁), Θ(χ₂)],
$$Θ ( {χ}_{i} ) = \{ \begin{matrix}1 , & if {χ}_{i} \geq 0 \\ 0 , & if {χ}_{i} < 0\end{matrix} ,$$
i=1,2, q₂=[θ₁ θ₂]^{T}, and θ₁ θ₂ denote payload swing angles.

17. The medium storing a program according to claim 14, wherein:
the sliding mode surface vector is as follows:
s=e+λė=[s₁ s₂]^{T}
wherein λ denotes the positive definite diagonal control matrix, and e denotes a positioning error vector.

18. The DES12. The medium storing a program according to claim 15, wherein:
the sliding mode surface vector is as follows:
s=e+λė=[s₁ s₂]^{T}
wherein λ denotes the positive definite diagonal control matrix, and e denotes a positioning error vector.

19. The medium storing a program according to claim 16, wherein:
the sliding mode surface vector is as follows:
s=e+λė=[s₁ s₂]^{T}
wherein λ denotes the positive definite diagonal control matrix, and e denotes a positioning error vector.
